(19) United States
(12) Patent Application Publication
(10) Pub. No.: US 2015/0100603 A1
(43) Pub. Date: Apr. 9, 2015

(54) METHOD FOR CHECKING THE DATA OF A DATABASE RELATING TO PERSONS

(71) Applicant: Olivier Cipiere, Issy-Les-Moulineaux (FR)

(72) Inventor: Olivier Cipiere, Issy-Les-Moulineaux (FR)

(21) Appl. No.: 14/400,244

(22) PCT Filed: Apr. 25, 2013
(86) PCT No.: PCT/EP2013/058588

§ 371 Date: Nov. 10, 2014

(30) Foreign Application Priority Data
May 9, 2012 (FR) 12 54220

(51) Int. Cl. G06F 21/62

(52) U.S. Cl. CPC G06F 21/6254; G06F 21/6227
USPC 707/785

(57) ABSTRACT

The invention provides a method of automatically verifying certain items in a database relating to a set of people, and including for each person a plurality of data items such as age, first name, gender, a portrait, fingerprint images, or other biometric data items, the method incorporating determining for each person a plurality of correlations associating certain data items of that person with one another, for each data item being verified, calculating a confidence score depending at least on a first correlation of the data item being verified with a first other data item for the same person and on a second correlation of the data item being verified with a second other data item for the same person, and a step of comparing the score with a threshold value in order to determine whether the data item being verified is or is not valid.

The invention relates to verifying the content of a database storing data relating to people, such as firstname, age, date of birth, sex, portrait, fingerprints, and/or other biometric data, for the purpose of identifying inputting errors and/or attempts at fraud in the data stored in the database.

### SUMMARY OF THE INVENTION

To this end, the invention provides a method of automatically verifying certain items in a database relating to a set of people, and including for each person a plurality of data items such as age, firstname, gender, the method incorporating:
determining for each person a plurality of correlations associating certain data items of that person with one another;
for each data item being verified, calculating a confidence score depending at least on a first correlation of the data item being verified with a first other data item for the same person and on a second correlation of the data item being verified with a second other data item for the same person; and
a step of comparing the score with a threshold value in order to determine whether the data item being verified is or is not valid.

The invention also provides a method as defined above, wherein the data stored for each person includes firstly gender together with date of birth, and secondly a portrait and a fingerprint, and wherein the method establishes, for each person, correlations between gender and age with the portrait and with the fingerprint.

The invention also provides a method as defined above, wherein the data stored for each person includes firstname, and wherein the method establishes, for each person, a correlation corresponding to statistics obtained from national data and representing the frequency of that person's firstname for that person's year of birth.

The invention also provides a method as defined above, enabling a correlation value to be obtained corresponding to statistics derived from national data representing the frequency of the firstname of the person under consideration for that person's year of birth and gender.

### BRIEF DESCRIPTION OF THE FIGURES

FIG. 1 is a graph with a cloud of points representing a population of men represented by triangles and women represented by circles, with age in years being plotted along the abscissa axis and with the breadth of fingerprint ridges in millimeters being plotted up the ordinate axis for each individual;

FIG. 2 is the graph of FIG. 1 showing a middle region and a bottom region that constitute respectively a zone of confidence and a zone of suspicion for the male gender;

FIG. 3 is the graph of FIG. 1 showing a top region and a middle region that constitute respectively a zone of suspicion and a zone of confidence for the female gender;

FIG. 4 is the graph of FIG. 1 showing a middle region that constitutes a zone of confidence for age, together with a top zone and a bottom zone that constitute zones of suspicion for age; and

FIG. 5 is a graph showing the yearly frequency of the firstname Jacob for boys born in the United States, with year of birth plotted along the abscissa axis and with frequency per thousand individuals plotted up the ordinate axis.

### DETAILED DESCRIPTION OF THE INVENTION

The idea on which the invention is based is to determine for each person a plurality of correlations, each associating certain items of data about that person, and to combine these correlations in order to identify individually and directly each data item that appears to be inconsistent, instead of doing no more than identifying each person for whom the data appears to be inconsistent.

This is done by evaluating for each data item being verified (firstname, date of birth, or gender) its consistency with at least two other distinct data items relating to the same person. The confidence score for a data item is thus determined by performing a calculation that combines the correlation value for that data item with a first other data item, and the correlation value of that data item with a second other data item.

The score for each data item being verified is then compared with a threshold value in order to determine whether the verified item should be considered as being valid or as being doubtful, in order to generate an alert message in the event of an item being doubtful.

In the example below, the invention is used to verify the sex, the age, and the firstname of a set of people or individuals stored in a database together with additional data including in particular a fingerprint and a portrait for each of the people.

Specifically, there exists a correlation between the breadth of the ridges in an individual's fingerprint and that individual's sex, and there exists another correlation between the breadth of those ridges and the age of the individual in question. This is described in detail in the article entitled “Epidermal ridge breadth, an indicator of age and sex in paleodermatoglyphics” by Miroslav Kralik and Vladimir Novotny, which article is available at the following address:
http://www.staff.amu.edu.pl/˜anthro/pdf/ve/vol011/01kralik.pdf

In analogous manner, there is a correlation associating the portrait of an individual and that individual's sex, and another correlation associating the portrait of that individual with age. This is described in detail in particular in the article entitled “Estimating age, gender, and identity using firstname priors” by Andrew Gallagher and Tsuhan Chen, accessible from the following address:
http://chenlab.ece.cornell.edu/people/Andy/projectpage_names.html

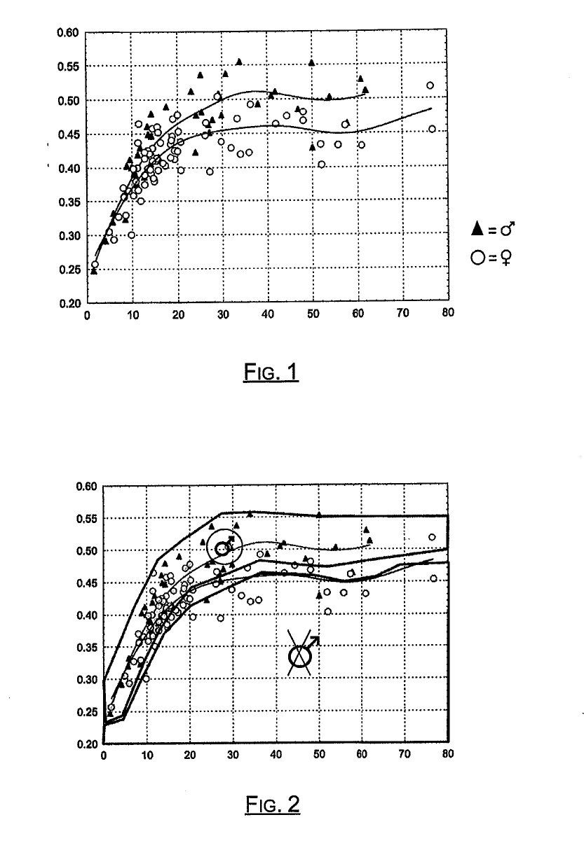

As shown in FIG. 1, the breadth of fingerprint ridges in a population is generally speaking greater for men than for women, and it also increases with an individual's age in that population.

It is thus possible in this graph to define a middle region that corresponds to a zone of confidence for the male gender, and a bottom region that corresponds to a zone of suspicion for the male gender.

As shown in FIG. 2, the zone of confidence for the male gender corresponds to a strip covering most men (represented by triangles), and the zone of suspicion for the male gender is a region situated under the male gender zone of confidence and that includes practically no male individuals.

The zone of confidence for the male gender is identified in FIG. 2 by the male symbol in a ring, and it may be specified by defining firstly a mean curve for values for the male gender, corresponding to the high curve in FIG. 1, and by defining on either side of the mean curve two envelope curves serving to contain e.g. 95% of the male population.

In analogous manner, the zone of suspicion for the male gender, as identified in FIG. 2 by the male symbol crossed out, can be determined by defining an upper bound curve situated under the mean curve for the male gender, but above only 2% of the male individuals. The zone of suspicion for the male gender is then constituted by any region situated under the curve as defined in this way.

It is thus possible to determine a correlation, written Cge, between the gender of a person recorded in the database as being a man and that person's fingerprint: one possibility consists in determining whether the point defined by that person's age and by the ridge breadth of that person's fingerprint is situated in the zone of confidence for the male gender, or on the contrary in the zone of suspicion.

A value of 1 may then be given to Cge if the point lies within the zone of confidence for the male gender, and a value of 0 may be given to the correlation if the point lies in the zone of suspicion. An intermediate value, e.g. 0.5, may be given if the point is situated outside the zone of confidence and outside the zone of suspicion.

Another solution may consist in calculating the distance between the point defined by age and fingerprint ridge breadth from the mean curve for the male gender (high curve in FIG. 1), and to give Cge a value lying in the range 0 to 1 that increases with decreasing value for this distance.

It is possible in analogous manner to define a zone of confidence and a zone of suspicion for the female gender.

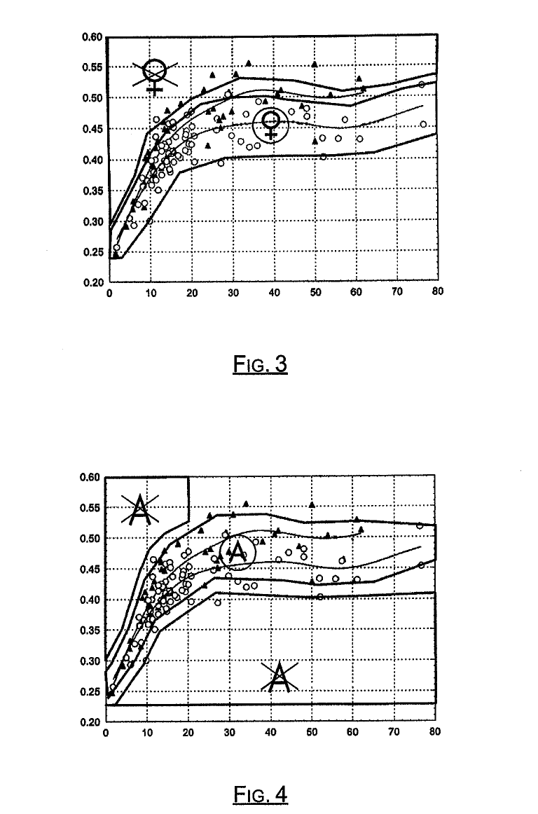

As shown diagrammatically in FIG. 3, the zone of confidence for the female gender, which is identified by a female symbol in a ring, is a strip situated in a middle position of the graph, and that surrounds the mean curve for women, i.e. the low curve in FIG. 1, so as to cover a large proportion, such as 95% of female individuals.

The zone of suspicion for the female gender, identified by the female symbol crossed out, is a top region situated above the zone of confidence, so as to cover a very small proportion of female individuals, such as 2%, for example.

As for the male gender, it is possible to give Cge a value of 1 for all of the individuals stated to be female that come within the zone of confidence for the female gender, and the value 0 for individuals recorded as being women but lying in the zone of suspicion for the female gender. An intermediate value, e.g. 0.5, is given to Cge if the point lies outside the zone of confidence and outside the zone of suspicion.

Once more, another possibility may consist in determining for a given individual recorded as a woman the distance between the point corresponding to that woman's age and fingerprint ridge breadth, and the mean curve for women, which is the low curve in FIG. 1. The value in the range 0 to 1 that is given to Cge then increases with decreasing value for the distance in question.

As mentioned above, there is also a correlation, written Cae, between the fingerprint ridge breadth and the age of the individuals under consideration. This correlation makes it possible to define on the graph of FIG. 1 a zone of confidence together with two zones of suspicion concerning age.

The zone of confidence for age, identified by the letter A in a ring in FIG. 4, is a middle strip covering the majority of individuals (men and women) in the population under consideration. This middle strip may be defined by calculating initially the mean curve for all of the individuals, which corresponds to the mean between the high and low curves in FIG. 1, and then by determining two envelope curves situated above and below the mean curve in order to cover e.g. 95% of the individuals.

The two zones of suspicion relating to age, identified by the letter A crossed out in FIG. 4, correspond to two regions situated respectively above and below the middle zone of confidence for age, these two zones of suspicion covering a very small proportion of the individuals in the population, e.g. corresponding to 2% of the population.

Determining the value for the correlation Cae between age and fingerprint for a given individual can likewise be performed by determining whether the point corresponding to the individual in question lies in the zone of confidence or in a zone of suspicion for age, in order to give Cae the value 1 or the value 0. Another solution likewise consists in determining the distance between the point representing the individual under consideration from the mean curve for all of the individuals, so as to give the correlation Cae a value lying in the range 0 to 1, which value increases with decreasing value for the distance.

It can thus be understood that the graph of FIGS. 1 to 4, showing data that results for example from taking statistics on a given population sample makes it possible, for each of the people recorded in the database, to determine a correlation Cge between that person's gender and fingerprint, and a correlation Cae between that person's age and fingerprint.

The portrait of each person recorded in the database serves to establish two other correlations relating to that person's age and gender.

A correlation between age and portrait, written Cap, may be established by initially providing a system with a series of portraits each associated with a real age. Thereafter, when the system is provided with an unknown portrait, it compares it with the series of portraits that it has available and that constitutes its reference database for determining the portraits that are most alike, possibly by calculating a degree of resemblance. Age is then determined by calculating an average, weighted by degrees of resemblance, for the ages of portraits that look alike. A correlation written Cgp between gender and portrait is established in analogous manner.

In addition, external statistics may be used for establishing one or more additional correlations for each person stored in the database.

In particular, there usually exist national statistics that make it possible to determine the proportion of births of a given gender that are represented by a given firstname, year by year.

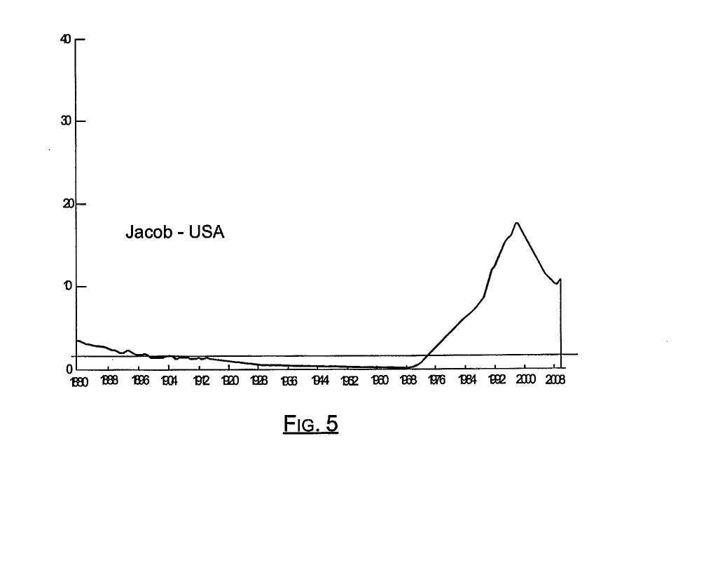

Such statistics make it possible to draw up a graph such as the graph of FIG. 5, which gives the proportion of boy births represented by the firstname Jacob born in the United States since 1830, year by year.

This graph makes it possible to establish a correlation, written Cpa, relating the firstname and the age of a given individual. The value of the correlation in question may be determined by considering that it is small, and for example is equal to 0, if the proportion of births for the firstname under consideration and for the year of birth under consideration is less than a threshold value, which threshold value may for example be one or two per thousand births.

Under such circumstances, the correlation Cpa for firstname with age is low for a person having the firstname Jacob and born in 1956 in the United States, which means that there might be an input error, e.g. concerning that person's date of birth, insofar as the firstname in question, namely Jacob, for boys born in 1976 in the United States represents more than one or two boy births per thousand.

Another way of determining the correlation value Cpa may consist in calculating a numerical value that decreases with decreasing frequency of the firstname in question for the year under consideration.

In analogous manner, and as will readily be understood, these statistics about firstnames also make it possible to determine a correlation value between firstname and gender, written Cpg, given that these statistics are generally available for boys and for girls for each year of birth.

Finally, for each person appearing in the database, the following six correlations are established: Cap=age-portrait; Cae=age-fingerprint; Cgp=gender-portrait; Cge=gender-fingerprint; Cpa=firstname-age; Cpg=firstname-gender, with all of these correlations having values lying in the range 0 to 1.

These correlations are then combined to determine for each person a score relating to their gender, a score relating to their age, and a score relating to their firstname.

The correlations may be combined directly to define each score, on the basis of which it is then possible to define for each score a confidence threshold and a suspicion threshold. The data is then considered as being valid if its score is greater than the confidence threshold, and doubtful if its score is less than the suspicion threshold, which then leads to an alert being established. It is possible to decide that data having a score lying between those two thresholds is either doubtful or valid.

A score associated with a particular data item may merely by the sum of the correlations involving that data item, possibly divided by the number of correlations that have been added together in order to ensure that the result has a value that necessarily lies in the range 0 to 1. The suspicion threshold and the confidence threshold may be determined empirically.

Another possibility may consist in calculating the scores for each of the data items after converting correlation value into a “suspicion” value that may be equal either to 0, or to 1, or to 2, depending on whether the correlation in question has a score that is respectively greater than a confidence threshold, lying between a confidence threshold and a suspicion threshold, or is less than the suspicion threshold.

This solution makes it possible to define thresholds not relative to the scores that themselves result from combining a plurality of correlations, but directly relative to the correlations for which performance and/or reliability levels are generally known, thus necessarily making it easier to determine the threshold.

Under such circumstances, the score given to the age item may then be:

1−(Sap+Saf+Sna)/3

the score given to the gender item then being equal to:

1−(SSgp+SSgf+SSng)/3

and the score given to the firstname item is equal to:

1−(SSng+Ssna)/2

It is possible to decide to issue an alert for each data item having a score that is negative, and to consider that an item is valid if its score is equal to 1. It is possible to consider that data items having a score lying in the range 0 to 1 are either doubtful, or valid, or indeed that they could give rise to an alert of lesser importance.

As can be understood, the invention is performed in a computer system having processor, memory, etc. type means for running a computer program in order to process the content of a database. The program then analyses the content of the database that is submitted to the program in order to process the database and return a list of data items that appear doubtful. Once the correlation statistics have been established on a representative sample, the invention also makes it possible to evaluate in real time the confidence to be given to identity data being input manually.

Furthermore, concerning the age of individuals in a database, this is generally determined on the basis of a date of birth stored for each individual. Advantageously, the database includes the date of acquisition of a portrait and/or of the fingerprint of each person, and the age that is taken into account is then the age of the person at the acquisition date of the portrait and/or the fingerprint.

1. A method of automatically verifying certain items in a database relating to a set of people, and including for each person a plurality of data items such as age, first name, gender, a portrait, fingerprints, or other biometric data items, the method incorporating:
determining for each person a plurality of correlations associating certain data items of that person with one another;
for each data item being verified, calculating a confidence score depending at least on a first correlation of the data item being verified with a first other data item for the same person and on a second correlation of the data item being verified with a second other data item for the same person; and
a step of comparing the score with a threshold value in order to determine whether the data item being verified is or is not valid.

2. The method according to claim 1, wherein the data stored for each person includes firstly gender together with date of birth, and secondly a portrait and a fingerprint, and wherein the method establishes, for each person, correlations between gender and age with the portrait and with the fingerprint.

3. The method according to claim 2, wherein the data stored for each person includes first name, and wherein the method established, for each person, a correlation corresponding to statistics obtained from national data and representing the frequency of that person's first name for that person's year of birth.

4. The method according to claim 3, enabling a correlation value to be obtained corresponding to statistics derived from national data representing the frequency of the first name of the person under consideration for that person's year of birth and gender.
